(19) United States
(12) Patent Application Publication
(10) Pub. No.: US 2005/0135852 A1
(43) Pub. Date: Jun. 23, 2005

(54) Image forming apparatus

(75) Inventor: Hajime Sekiguchi, Kashiwa-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/011,183

(22) Filed: Dec. 15, 2004

(30) Foreign Application Priority Data
Dec. 22, 2003 (JP) 2003-424567

(51) Int. Cl. G03G 21/00

(52) U.S. Cl. 399/349; 399/350; 399/356

(57) ABSTRACT

To provide an image forming apparatus capable of improving the deterioration of an image by cleaning a photosensitive drum with stability and by use of the photosensitive drum and the cleaning roller. In an image forming apparatus of the type in which a toner image formed on a photosensitive drum 1 is transferred to form a color image and in which the toner remaining on the photosensitive drum 1 after the toner imager is transferred is cleaned by cleaning means, the cleaning means includes a cleaning blade 30 for removing the toner remaining on the photosensitive drum 1 and a magnet roller 31 that is arranged nearer to the upstream side in the rotational direction of the photosensitive drum 1 than the cleaning blade 30 and is made to abut against by the photosensitive drum 1, thereby being rotated, and the magnet roller 31 is rotated independently of the rotating of the photosensitive drum 1.

### BACKGROUND OF THE INVENTION

1. Field of the Invention

The present invention relates to an image forming apparatus using an electrophotographic type or an electrostatic recording type and in particular, to an image forming apparatus such as copying machine, printer, facsimile, and the like.

2. Description of the Related Art

An image forming apparatus for forming an image by use of an electrophotographic type such as copying machine, printer, facsimile, and the like has been conventionally proposed and put into practice.

A conventional image forming apparatus for forming a white-and-black image uses an amorphous silicon photosensitive member in consideration of elongating the life of the photosensitive member. Further, in such a white-and-black image forming apparatus, the photosensitive member is cleaned by use of a magnet roller. To be more specific, the photosensitive member is cleaned by putting magnetic toner born by the magnet roller into sliding contact with the surface of the amorphous silicon photosensitive member to remove the toner remaining on the surface of this photosensitive member.

On the other hand, also in an image forming apparatus for forming a color image, similarly, in order to elongate the life of the photosensitive member, as disclosed in Japanese Patent Laid-Open No. 2003-241594, a technology is disclosed in which an amorphous silicon photosensitive member is used for an color image forming apparatus and in which the above-described magnet roller is used as the cleaning unit of this photosensitive member. Further, in the apparatus disclosed in the patent, a reduction of costs is carried out by using a source for rotating the photosensitive member also as a source for rotating the magnet roller.

However, when a construction was adopted in which a source for rotating the photosensitive member was also used as a source for rotating the magnet roller for the color image forming apparatus, it was found that a new malfunction which was not caused by the white-and-black image forming apparatus was caused, as will be described later.

This magnet roller has N magnetic poles and S magnetic poles arranged alternately side by side in a peripheral direction and it was found that unevenness had developed in the thickness of the magnetic toner according to these magnetic poles. When the magnetic toner having the unevenness in the thickness according to many poles is put into sliding contact with the photosensitive member, the effect of variations in the load applied to the source for rotating the magnetic roller may be transferred to the photosensitive member via a drive train to cause variations in the rotational speed of the photosensitive member.

For this reason, variations in the rotational speed of the photosensitive member associated with the variations in the load of the magnet roller caused unevenness appearing at pitches in a toner image formed on the photosensitive member. The toner image causing such unevenness appearing at pitches is sequentially superposed over a recording material or an intermediate transfer member to cause the respective toner images to be out of register, which results in causing malfunctions of out-of-register colors and variations in color.

### SUMMARY OF THE INVENTION

One object of the invention is to provide a color image forming apparatus capable of preventing variations in the rotational speed of an image bearing member associated with variations in the load of a rotating member.

Another object of the invention is to provide a color image forming apparatus capable of forming an image having no out-of-register colors.

Still other objects of the invention will be made dear by reading the following detailed description of the invention by reference to the accompanying drawings.

### BRIEF DESCRIPTION OF THE DRAWINGS

FIG. 1 is a schematic illustration of an image forming apparatus;

FIG. 2 is an illustration to show the construction of a cleaning unit;

FIG. 3 is an illustration to show the transmission path of drive force of an image bearing member and an intermediate transfer member and the arrangement of a cleaning unit;

FIG. 4 is a graph to show the relationship between the rotational speed of a cleaning roller and rotational load;

FIG. 5 is a graph to show the relationship between the rotation of the cleaning roller and toner buildup; and

FIG. 6 is a schematic illustration of an image forming apparatus to show a modification.

### DETAILED DESCRIPTION OF THE PREFERRED EMBODIMENTS

Next, an image forming apparatus in accordance with one embodiment of the invention will be concretely described by reference to the accompanying drawings.

[First Embodiment]

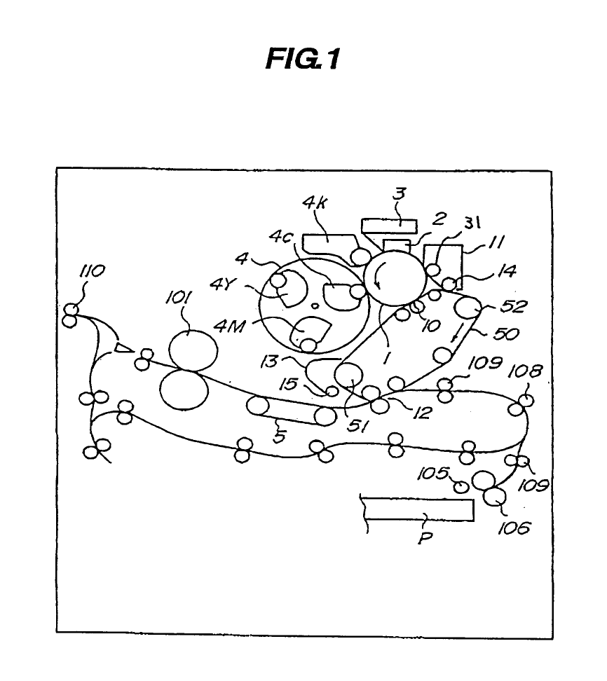

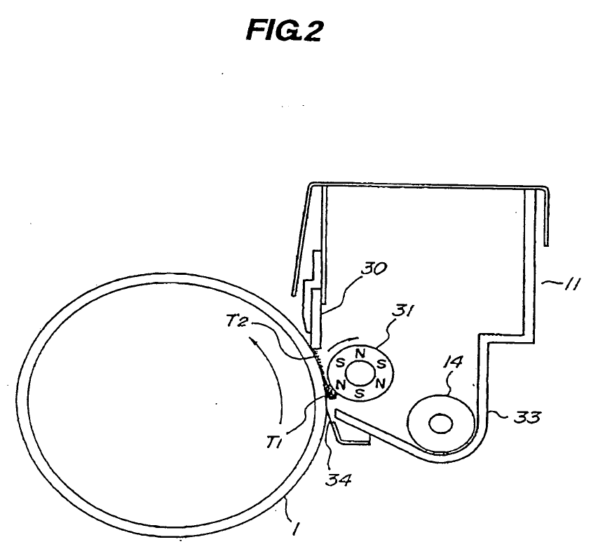

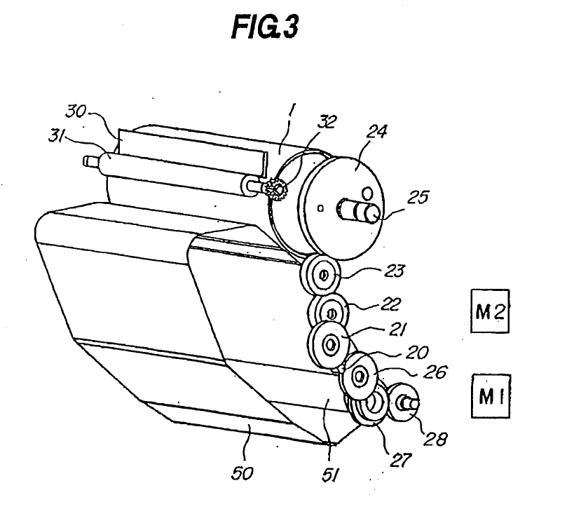

FIG. 1 is a schematic illustration of an image forming apparatus. FIG. 3 is an illustration to show the transmission path of drive force of an image bearing member and an intermediate transfer member and the arrangement of a cleaning unit. FIG. 2 is an illustration to show the construction of a cleaning unit.

{Image Forming Apparatus}

First, a brief description of general construction of an image forming apparatus of this embodiment will be given by reference to FIG. 1. The image forming apparatus in accordance with this embodiment is a color image forming apparatus using an intermediate transfer member.

An electrostatic latent image is formed, by an exposure unit 3 as image forming means, on a photosensitive drum 1 as an image bearing member that is uniformly charged by a charging unit 2 as image forming means. This electrostatic latent image is sent to a development part by the rotation of the image bearing member and is developed by a development unit as image forming means.

A toner image is primarily transferred at a primary transfer nip 10 to an intermediate transfer member (hereinafter referred to as intermediate transfer belt) 50 as a transfer medium by a transfer unit as transfer means.

In this embodiment, a rotary development unit 4 is used as the development unit and is rotatably provided with a yellow development unit 4Y, a cyan development unit 4C, and a magenta development unit 4M that develop toners of the respective colors of yellow (Y), cyan (C), and magenta (M) by use of two-component developing agent (magnetic carrier and nonmagnetic toner).

Further, a black development unit 4K that forms a black (K) toner image by use of one-component developing agent (magnetic toner) is arranged close to the rotary development unit 4. The black development unit 4K that uses the magnetic toner does not produce waste carrier, which is produced by a two-component development unit, so that the black development unit 4K can be independent of the other development units. This arrangement can improve service performance in the forming of monochromatic images that are used at a relatively high frequency.

The above-described rotary development unit 4 is rotated to oppose the respective color development units 4Y, 4C, 4M in sequence to the photosensitive drum 1 and respective color toner images are primarily transferred to the intermediate transfer belt 50 by the respective color development units 4Y, 4C, 4M, and the black development unit 4K in such a way that the respective color toner images are superimposed over each other to form a color image. The toner image is secondarily transferred by a secondary transfer nip 12 to a sheet P transported by respective transport rollers 105, 106, 107, 108, and 109 that become sheet transport means for transport a recording material (hereinafter referred to as “sheet”). Further, the sheet P to which the toner image is transferred is carried by a transport belt 5 to a fixing unit 101 where heat and pressure are applied to the sheet P to fix the toner image and then the sheet P is discharged outside the unit by a discharge roller 110.

On the other hand, primary transfer residual toner remaining on the photosensitive drum 1 after the toner image is primarily transferred to the intermediate transfer belt 50 is removed by a cleaning unit 11 as cleaning means and the toner taken into the cleaning unit 11 is recovered by a toner transporting screw 14 into a waste toner recovery box (not shown).

Further, secondary transfer residual toner remaining on the intermediate transfer belt 50 after the toner image is secondarily transferred to the sheet is removed by a belt cleaner 13 and the toner in the cleaner 13 is recovered by a toner transporting screw 15 into a waste toner recovery box (not shown).

{Cleaning Unit}

Next, the construction of the cleaning unit 11 for removing the toner remaining on the photosensitive drum 1 will be described by reference to FIG. 2.

As shown in FIG. 2, the cleaning unit 11 is arranged adjacently to the photosensitive drum 1 to be rotated. A cleaning blade 30 that abuts against the surface of the photosensitive drum 1 and scrapes the toner remaining on the photosensitive drum 1 is held by a cleaning box 33 of this cleaning unit 11.

A cleaning roller 31 as a rotary member, to be specific, a magnet roller is rotatably provided on the upstream side in the direction, in which the photosensitive drum 1 is rotated, of the cleaning blade 30 (hereinafter simply referred to as “upstream side”) in such a way as to form a predetermined gap between the cleaning blade 30 and the photosensitive drum 1.

Further, a squeegee 34 for preventing the toner from leaking from the cleaning box 33 is fixed on the upstream side of the cleaning roller 31. The cleaning blade 30 and the squeegee 34 of this embodiment are respectively constructed of urethane rubber plates of 2 mm and 0.1 mm in thickness.

The magnet roller 31 of this embodiment is constructed of a roller having a diameter of 17.7 mm and six alternately arranged magnetic poles of N poles and S poles each having a magnetic flux of 750 gauss. This magnet roller 31, as will be described later, is so constructed as to be rotated in a normal direction with respect to the rotation of the photosensitive drum 1 and at a speed slightly faster than the rotational speed of the photosensitive drum 1 by drive means constructed of a drive motor as drive source and a drive gear train.

When the residual toner (magnetic toner) that is not transferred to the sheet at the primary transfer nip 12 but remains on the photosensitive drum 1 reaches the position of the cleaning unit 11 as the photosensitive drum 1 is rotated, the residual toner is attracted and transported by the magnet roller 31 of this cleaning unit 11. Further, the residual toner remaining on the photosensitive drum 1 is scraped away by the cleaning blade 30 and the scraped residual toner is dropped on the magnet roller 31, whereby toner buildup T1 is formed between the magnet roller 31 and the photosensitive drum 1.

Further, while the dropped toner is attracted and transported by the magnet roller 31, the toner is supplied from the magnet roller 31 to the photosensitive drum 1 and, as a result, is supplied to the abutting edge portion of the cleaning blade 30 to form a toner layer.

That is, the toner dropped on the magnet roller 31 sticks up on the surface of the magnet roller 31 to form a magnetic blush and reaches a position opposed to the photosensitive drum 1 in sequence as the magnet roller 31 is rotated to perform a scrubbing and cleaning action to scrub away various kinds of foreign particles attached to the surface of the photosensitive drum 1. The magnet roller 31 is put into scrubbing contact with the photosensitive drum 1 to coat the photosensitive drum 1 again with a toner layer T2. This toner reaches the cleaning blade 30 to reduce the frictional force between the photosensitive drum 1 and the cleaning blade 30, thereby preventing the cleaning blade 30 from being finely vibrated.

Further, the photosensitive drum 1 of this embodiment is a non-organic photosensitive member in which photosensitive material such as amorphous silicon or the like is formed on a cylindrical substrate made of aluminum, nickel, or the like, and the surface of the photosensitive drum 1 is scrubbed by the magnetic blush of the rotating magnet roller 31, thereby being polished.

{Transmission of Drive Force to Photosensitive Drum, Intermediate Transfer Belt, and Magnet Roller}

Next, the construction of transmission of drive force to the photosensitive drum 1, the intermediate transfer belt 50, and the magnet roller 31 in this embodiment will be described.

The rotation of the photosensitive drum 1 and the intermediate transfer belt 50 is controlled by the drive force of a motor M1 as a common drive source. That is, as shown in FIG. 3, the photosensitive drum 1 and the intermediate transfer belt 50 are driven by a motor gear 20 for transmitting output from the motor M1.

As for a transmission path of a drive force for rotating the photosensitive drum 1, the drive force is transmitted from the motor gear 20 to a drum stage gear 21, a driven gear 22, a driven gear 23, and a drum gear 24. The drum gear 24 and the photosensitive drum 1 are fixedly coupled to each other by a drum shaft 25 and when the drum gear 24 is rotated, the photosensitive drum 1 is rotated.

On the other hand, as for a transmission path of a drive force for rotating the intermediate transfer belt 50, the drive force 1 is transmitted from the motor gear 20 to a first belt stage gear 26, a second belt stage gear 27, and a belt driving gear 28. The belt driving gear 28 is coupled to the belt driving roller 51 by a coupling, and when the belt driving roller 51 is rotated, the intermediate transfer belt 50 looped over a drive roller 51, a driven roller 52, and the like is rotated.

Further, the toner remaining on the photosensitive drum 1, as described above, is scraped by the cleaning blade 30 in the cleaning unit and is recovered by the magnet roller 31 and this magnet roller 31 is rotated by a roller gear 32 provided on its end portion.

This roller gear 32 has a drive force transmitted thereto from the a drive motor M2 as another drive source separate from the motor M1 for driving the photosensitive drum 1 and the intermediate transfer belt 50, thereby being rotated.

As described above, the magnet roller 31 that is a cleaning assisting member of the cleaning unit is so constructed as to be driven by independent drive means composed of a drive motor different from the drive motor M1 for driving the photosensitive drum 1 and the intermediate transfer belt 50.

With this, the transmission path of the drive force of the photosensitive drum 1 and the intermediate transfer belt 50 is not affected by the load variations of the magnet roller 31.

Therefore, variations in the rotational speeds of the photosensitive drum 1 and the intermediate transfer belt 50, which are developed in the related art to present a problem, can be reduced to prevent unevenness appearing at pitches in the image and out-of-register superimposed colors, which results in improving the quality of the image.

{Special Sheet Mode}

This embodiment is constructed in such a way that the rotational speed of the magnet roller 31 and the rotational speeds (image forming speeds) of the photosensitive drum 1 and the intermediate transfer belt 50 can be changed independently of each other. Then, this embodiment is constructed in such a way that the rotational speed of the photosensitive drum 1 is changed according to the kind of sheet as recording material, for example, in the case of using a special sheet such as thick sheet having thermal capacity and OHT sheet, and the rotational speed of the magnet roller 31 is also changed in accordance with this. Next, an image forming operation in a special sheet mode will be described.

In the special sheet mode, the sheet transport speed of a fixing unit 101 is reduced to stabilize the fixing performance of a special sheet. Describing this specifically, the operation of primary transfer of an image from the photosensitive drum 1 to the intermediate transfer belt 50 is the same as in normal mode.

In the special sheet mode, after the primary transfer of respective color toner images to the intermediate transfer belt 50 at the primary transfer nip 10 is completed, the rotational speeds of the photosensitive drum 1 and the intermediate transfer belt 50 are reduced from a normal speed and are so controlled as to become a sheet transport speed that is nearly equal to the speed of the fixing unit (that is slower than the sheet transport speed).

With this, even if a special sheet enters between a pair of fixing rollers of the fixing unit in a state where a special sheet is at the secondary transfer nip 12, excellent images can be formed without causing sheet transport to be impaired and an image to deteriorate.

When the next image is formed in succession, the rotational speeds of the photosensitive drum 1 and the intermediate transfer belt 50 are again returned to the normal speeds to repeat the above-described image forming operation.

Further, depending on the specification of the image forming apparatus, in some cases, the rotational speeds of the photosensitive drum 1 and the intermediate transfer belt 50 are reduced (brought to a rotational speed equal to the speed of the fixing unit) to perform secondary transfer while the intermediate transfer belt 50 is rotated one rotation in a state where the toner image is held on the intermediate transfer belt 50.

In this manner, in the special sheet mode, the toner image of the intermediate transfer belt 50 is brought into a state where it undergoes the effect of vibrations and the like. In particular, when the toner image formed by four colors passes through the primary transfer nip 10, it is desired to reduce variations in the rotation of the photosensitive drum 1 and the intermediate transfer belt 50 and vibrations of them when the image is transferred to the special sheet at the secondary transfer nip 12 to the extent possible.

Therefore, in this embodiment, the magnet roller 31 is driven and controlled independently by a drive motor different from the drive motor of the photosensitive drum 1 and the intermediate transfer belt 50 and the rotational speed of the magnet roller 31, as will be described later, is also reduced in accordance with the reduced speed of the photosensitive drum 1 to improve variations in the rotational speeds of the photosensitive drum 1 and the intermediate transfer belt 50 to prevent unevenness appearing at pitches in the image and out-of-register superimposed colors.

{Rotational Speed of Magnet Roller}

Next, the setting of the rotational speed of the magnet roller 31 in accordance with this embodiment will be described. As described above, when the image is formed on the special sheet, in order to secure fixing performance and to reduce the size of the fixing unit, in some cases, the image forming speed is reduced to ⅔ to ⅓ while the toner image is transferred to the sheet. In these cases, it turned out that although the magnet roller 31 is so constructed as to be independent of the photosensitive drum 1, when the rotational speed of the photosensitive drum 1 is varied, the rotational load of the magnet roller 31 is varied to cause variations in the rotation of the photosensitive drum 1, which causes the image to be out-of-register when it is transferred to the special sheet transfer and the next image to be out-of-register when it is formed. Further, this raises the possibility of presenting a problem that the toner falls in drops or the like.

Hence, in the image forming apparatus of this embodiment, the photosensitive drum 1 is constructed in such a way that its rotational speed is varied at three steps of a normal speed (1/1 speed), a speed of ⅔ times the normal speed (⅔ speed), and a speed of ⅓ times the normal speed (⅓ speed), and the magnet roller 31 is constructed in such a way that when the rotational speed of the photosensitive drum 1 is varied, the rotational speed is also controlled to 1/1 speed, ⅔ speed, and ⅓ speed with respect to the normal speed. This prevents variations in rotational load caused by the magnet roller 31 and hence prevents the above-described malfunction.

In the image forming apparatus of this embodiment, the normal speeds of the photosensitive drum 1 and the magnet roller 31 are set at 276 mm/sec and 303 mm/sec, respectively. Therefore, their ⅔ speeds are 184 mm/sec and 202 mm/sec, respectively, and their ⅓ speeds are 92 mm/sec and 101 mm/sec, respectively.

Next, the reason why the rotational speed of the magnet roller 31, as described above, is varied according to a change in the speed of the photosensitive drum 1 and the operation and effect produced by this action will be described.

(Relationship Between the Rotation of the Magnet Roller and Rotational Load)

First, the relationship between the difference in the rotational speed between the photosensitive drum 1 and the magnet roller 31 and the rotational load of the magnet roller 31 will be described.

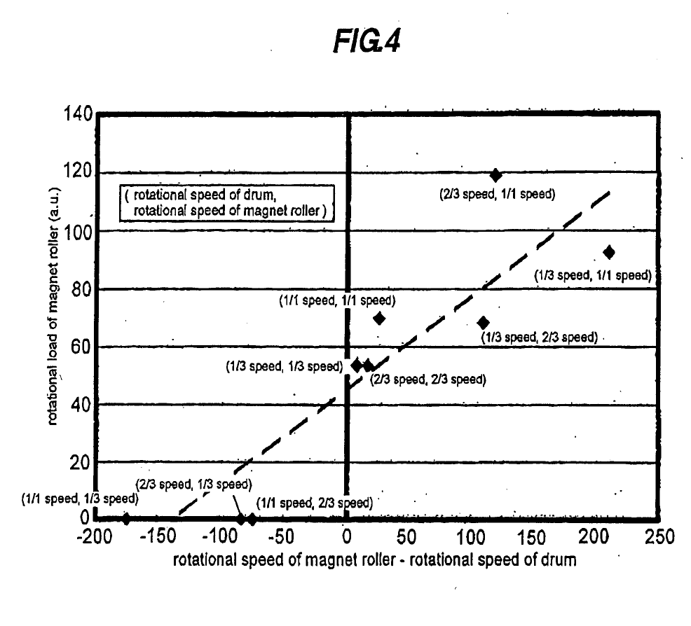

FIG. 4 is a graph to show the result obtained by checking the rotational load of the magnet roller 31 at the time when an endurance test of idling the magnet roller 31 was conducted for a predetermined time with the amount of toner on the magnet roller 31 kept at a constant value by use of the image forming apparatus in accordance with this embodiment. In FIG. 4, the rotational load applied to the magnet roller 31 at the time when the rotational speeds of the photosensitive drum 1 and the magnet roller 31 were varied in combination of 1/1 speed, ⅔ speed, and ⅓ speed is shown on the vertical axis whereas Vc−Vz (where Vc is the rotational speed of the magnet roller and Vz is the rotational speed of the photosensitive drum) is shown on the horizontal axis.

The rotational load of the magnet roller 31 was obtained by measuring an increase in the current of the drive motor of the magnet roller 31 during the idling endurance test.

As is clear from the result shown in FIG. 4, it was found that when the rotational speed of the magnet roller 31 was fixed at 1/1 speed, that is, the rotational speed of the magnet roller 31 was not varied and only the rotational speed of the photosensitive drum 1 was reduced from 1/1 speed to ⅔ speed and ⅓ speed, the rotational load of the magnet roller 31 was increased as compared with a case where the rotational speed of the photosensitive drum 1 was 1/1 speed. This is because the toner on the magnet roller 31 was not brought between the magnet roller 31 and the photosensitive drum 1 to apply load to the magnet roller 31, whereby the rotational load of the magnet roller 31 was increased.

Hence, it was found that: when the rotational speed of the photosensitive drum 1 was reduced, if the rotational speed of the magnet roller 31 was also reduced, the resistance between the magnet roller 31 and the photosensitive drum 1 and the amount of toner in the toner buildup were reduced and the toner on the magnet roller 31 was easily attached to the photosensitive drum 1 to reduce the rotational load of the magnet roller 31. In this manner, in this embodiment, variations in the load of the magnet roller 31 is reduced by reducing the rotational speed of the magnet roller 31 in accordance with the reducing of the rotational speed of the photosensitive drum 1.

Here, it was found that: assuming that the rotational speed of the photosensitive drum 1 and the rotational speed of the magnet roller 31 before speed reduction are V_{A} and V_{B} and the rotational speed of the photosensitive drum 1 and the rotational speed of the magnet roller 31 after speed reduction are Vₐ and V_{b}, if the relationship of the speed difference between the photosensitive drum 1 and the magnet roller 31 satisfies V_{b}−Vₐ≦V_{B}−V_{A}, the rotational load of the magnet roller 31 is not varied to prevent the image from being out of register when it is transferred to the special sheet and the next image from being out of register when it is formed.

(Relationship Between the Rotation of Magnet Roller and Toner Buildup)

Next, the relationship between the speed difference between the photosensitive drum 1 and the magnet roller 31 and the toner buildup between the magnet roller 31 and the photosensitive drum 1 will be described. When this toner buildup becomes too big, it causes the toner to fall in drops whereas when the toner buildup disappears, it causes load to increase when the cleaning blade scrapes the toner.

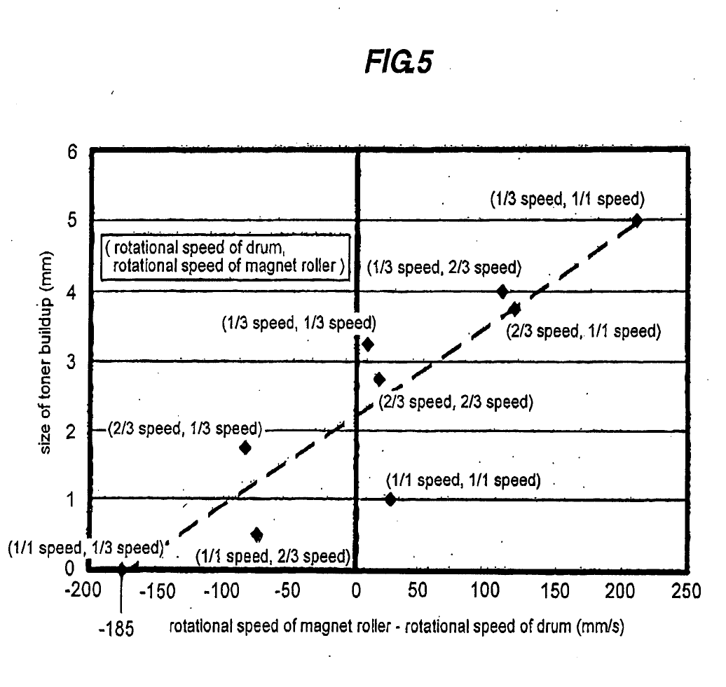

FIG. 5 is a graph to show the test result obtained by checking the size of toner buildup at the time of conducting an endurance test of idling the magnet roller 31 for a predetermined time with the amount of toner on the magnet roller 31 kept at a constant value by use of the image forming apparatus in accordance with this embodiment. To be more specific, the size of toner buildup at the time of varying the rotational speeds of the photosensitive drum 1 and the magnet roller 31 in combination of 1/1 speed, ⅔ speed, and ⅓ speed is shown on the vertical axis whereas V_{c}−V_{z} (where Vc is the rotational speed of the magnet roller and Vz is the rotational speed of the photosensitive drum) is shown on the horizontal axis.

The size of the above-described toner buildup is measured by removing the photosensitive drum 1 after the idling endurance test.

Here, the reason why the toner buildup T1 (see FIG. 2) develops will be described.

As described above, when the rotational speed of the magnet roller 31 is fixed at 1/1 speed and only the rotational speed of the photosensitive drum 1 is reduced, that is, when the rotational speed of the magnet roller 31 is increased relatively to the rotational speed of the photosensitive drum 1, the toner adhering to the magnet roller 31 is hard to enter between the magnet roller 31 and the photosensitive drum 1. As a result, overflowing toner builds up to form the toner buildup T1 (see FIG. 2). This is a phenomenon caused by the resistance between the magnet roller 31 and the photosensitive drum 1 being increased by the speed difference between the magnet roller 31 and the photosensitive drum 1.

On the other hand, on the contrary to the above case, when the rotational speed of the magnet roller 31 is decreased relatively to the rotational speed of the photosensitive drum 1, the toner on the magnet roller 31 is easily transported between the magnet roller 31 and the photosensitive drum 1 to reduce the size of the toner buildup.

Hence, when the rotational speed of the photosensitive drum 1 is reduced, the size of the toner buildup can be reduced by reducing the rotational speed of the magnet roller 31 in accordance with the reduced rotational speed of the photosensitive drum 1.

If the relationship of the speed difference between the photosensitive drum 1 and the magnet roller 31 satisfies V_{b}−Vₐ≦V_{B}−V_{A}, as described above, that is, if the amount of speed reduction of the magnet roller 31 is larger than the amount of speed reduction of the photosensitive drum 1, the toner buildup is reduced in size to prevent the toner from falling in drops.

However, it is not always true that the slower the rotational speed of the magnet roller 31 becomes, the better the result is. This is because if the rotational speed of the magnet roller 31 is reduced too much, the amount of toner transported by the photosensitive drum 1 becomes larger than the amount of toner supplied by the magnet roller 31 and hence the toner buildup between the magnet roller 31 and the photosensitive drum 1 disappears. Then, the toner to be applied again to the photosensitive drum 1 becomes lost, which results in increasing the frictional force between the photosensitive drum 1 and the cleaning blade 30.

Hence, it is desired not to make the rotational speed of the magnet roller 31 as slower as the toner buildup disappears.

Here, in the image forming apparatus of this embodiment, the rotational speed of the photosensitive drum 1 is set in such a way as to decrease at three steps of 1/1 speed, ⅔ speed, and ⅓ speed according to the kind of sheet and the rotational speed of the magnet roller 31 is also set in such a way as to decrease at three steps of 1/1 speed, ⅔ speed, and ⅓ speed. Hence, when the rotational speed of the magnet roller 31 relative to the rotational speed of the photosensitive drum 1 is made relatively slowest, that is, when the rotational speed of the photosensitive drum 1 is 1/1 speed and the rotational speed of the magnet roller 31 is ⅓ speed, the toner buildup easily disappears. The speed difference (V_{b}−Vₐ) at this time, as is clear from the test result shown in FIG. 5, was −185 mm/sec.

From this result, it is clear that if the speed difference between the photosensitive drum 1 and the magnet roller 31 satisfies a relationship of 0.3×V_{B}−V_{A}≦V_{b}−Vₐ, the toner buildup is as small as it does not disappear. Hence, it is clear that if the speed difference between the photosensitive drum 1 and the magnet roller 31 satisfies a relationship of 0.3×V_{R}−V_{A}≦V_{b}−Vₐ≦V_{B}−V_{A}, it is possible to prevent the toner from falling in drops and to prevent the frictional force between the photosensitive drum 1 and the cleaning blade 30 from being increased.

(Relationship Between the Rotation of Magnet Roller and the Load of Cleaning Blade)

Next, the relationship between the rotational speed difference between the photosensitive drum 1 and the magnet roller 31 and the friction load caused by the cleaning blade 30 will be described.

When the rotational speed of the photosensitive drum 1 is decreased, the rotational speed of the magnet roller 31 is also decreased in accordance with this. At this time, when rotational speed of the magnet roller is decreased too much, the magnet roller 31 is put into sliding contact with the photosensitive drum 1 to reduce the amount of toner to be applied again to the photosensitive drum 1. This toner layer has a function of preventing the frictional force between the photosensitive drum 1 and the cleaning blade 30 from increasing (function as a lubricating agent) and hence a reduction in the amount of toner increases the frictional force and increases the rotational load of the photosensitive drum 1.

Although the above result is obtained with regard to the magnet roller 31 used for the image forming apparatus of this embodiment, the same holds true even when a fur blush or a resin roller is used as the cleaning roller. That is, when the rotational speed of the photosensitive drum 1 is varied, the rotational load of the cleaning roller is varied to cause the rotational load of the photosensitive drum 1 to increase.

Further, in the case of using the fur blush, there are cases where when only the rotational speed of the photosensitive drum 1 is decreased, the amount of toner supplied to the fur blush is decreased and where the rotational speed of the fur blush is fast, the toner on the fur blush disappears and hence is not applied again to the photosensitive drum 1. For this reason, when the rotational speed of the photosensitive drum 1 is decreased, the rotational speed of the fur blush needs to be also decreased in accordance with this. However, if the rotational speed of the fur blush is decreased too much, the amount of toner discharged from the fur blush and the amount of toner applied again to the photosensitive drum 1 get out of balance to cause the fur blush to be filled with the toner.

Therefore, in this embodiment, as described above, the rotational speed of the photosensitive drum and the rotational speed of the cleaning roller are set in such a way that the difference between their rotational speeds satisfies the relationship of 0.3×V_{B}−V_{A}≦V_{b}−Vₐ, in other words, the rotational speed of the cleaning roller (magnet roller 31 in this embodiment) is set such that it does not become too slow to make the toner on the cleaning roller adhere to the photosensitive drum 1, thereby preventing the amount of toner applied again to the photosensitive drum 1 from being decreased too much.

As a result, it was found that the frictional force between the photosensitive drum 1 and the cleaning blade 30 was decreased to reduce the rotational load of the photosensitive drum 1 to prevent the image from being out of register when it was transferred to the special sheet or to prevent the image from being out of register when it was formed. Further, it was possible to reduce variation in the stress applied to the cleaning blade 30 and to prevent the cleaning blade 30 from vibrating finely, slipping the toner, and causing unusual noises.

[Other Embodiments]

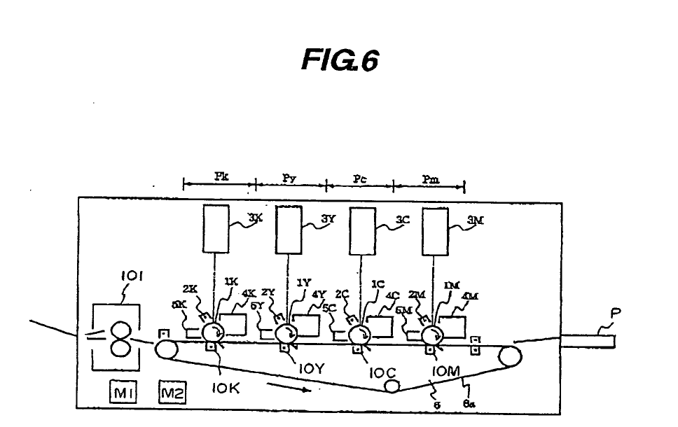

In the above-described embodiment has been shown the image forming apparatus of a rotary development type in which a plurality of development units are rotated to oppose to one photosensitive drum to form color images. However, the image forming apparatus of the invention is not limited to this embodiment but can be applied similarly also to an image forming apparatus provided with four image forming stations Pm to Pk as shown in FIG. 6. Part for performing the same functions as the parts described in the above-described embodiment are denoted by the same reference symbols in FIG. 6 in place of omitting their detailed descriptions.

To be more specific, even in an image forming apparatus of a tandem type in which the toner images of respective colors, which are formed on the photosensitive members at the respective image forming stations, are transferred in a superimposing manner to a recording material P as a transfer medium on the transfer belt 6 to produce a color image, the same effect can be produced by constructing the drive system of the photosensitive drum and the cleaning roller in the manner described above. In this embodiment, only the photosensitive drum 1K as a predetermined image bearing member, on which images are formed with the magnetic toner, is formed of an amorphous silicon photosensitive member and the above-described magnet roller is used as the cleaning unit of this photosensitive member. Other photosensitive drums 1M, 1C, and 1Y on which images are formed with the non-magnetic toner are formed of organic photosensitive material and the cleaning units of these photosensitive members are so constructed as to perform cleaning only by a cleaning blade without the above-described magnet roller.

Of the plurality of image forming stations, the number of stations that use the amorphous silicon photosensitive members and clean the photosensitive members by use of the magnet rollers is neither limited to the above-described number nor limited to a specific number.

Further, the invention can be applied similarly even to an image forming apparatus of the type in which: an intermediate transfer member as a transfer medium is arranged in place of the transfer belt in the embodiment shown in FIG. 6; a toner image is primarily transferred sequentially in a superimposing manner from the respective photosensitive members to the intermediate transfer member; and the toner image is secondarily transferred to a recording material.

Still further, the invention can be applied similarly also to an image forming apparatus of the type in which: the recording material is attracted by the transfer drum; the toner image is formed on the photosensitive drum by the rotary development unit; the toner image is transferred sequentially in a superimposing manner to the above-described rotating sheet to form a color image.

This application claims priority from Japanese Patent Application No. 2003-424567 filed Dec. 22, 2003, which is hereby incorporated by reference herein.

1. An image forming apparatus comprising:
an image bearing member;
a plurality of image forming means for forming images of toner of different colors on the image bearing member, at least one of the plurality of image forming means forming the image by use of magnetic toner;
transfer means for transferring the image formed on the image bearing member to a transfer medium sequentially in a superimposing manner; and
a rotary member provided with magnetic poles of different magnetic properties so as to bear the magnetic toner, the rotary member sliding the toner born thereon with respect to the image bearing member to clean the image bearing member,
wherein the image bearing member is rotated by a drive source that is different from a drive source for rotating the rotary member.

2. The image forming apparatus according to claim 1, wherein a rotational speed of the rotary member is varied in accordance with a reduction in a rotational speed of the image bearing member.

3. The image forming apparatus according to claim 2, wherein assuming that the rotational speed of the rotary member when a rotational speed of the image forming member is V_{A} is V_{B} and that the rotational speed of the rotary member when the rotational speed of the image forming member is decreased from V_{A} to Vₐ is V_{b}, the following relationship holds.
0.3×V_{B}−V_{A}≦V_{b}−Vₐ≦V_{B}−V_{A}

4. The image forming apparatus according to claim 1, further comprising a blade that abuts against and cleans the image forming member, wherein the rotary member supplies the toner to a portion where the blade abuts against the image bearing member.

5. An image forming apparatus comprising:
a plurality of image forming means for forming images of toner of different colors on a plurality of image bearing members, predetermined image forming means of the plurality of image forming means forming the image on a predetermined image bearing member by use of magnetic toner;
transfer means for transferring the images formed on the plurality of image bearing members to a transfer medium sequentially in a superimposing manner; and
a rotary member provided with magnetic poles of different magnetic properties so as to bear the magnetic toner, the rotary member sliding the toner born thereon with respect to a predetermined image bearing member to clean the predetermined image bearing member,
wherein the predetermined image bearing member is rotated by a drive source that is different from a drive source for rotating the rotary member.

6. The image forming apparatus according to claim 5, further comprising means for varying a rotational speed of the rotary member in accordance with the switching of a rotational speed of the image bearing member.

7. The image forming apparatus according to claim 6, wherein assuming that the rotational speed of the rotary member when the rotational speed of the image forming member is V_{A} is V_{B} and that the rotational speed of the rotary member when the rotational speed of the image forming member is decreased from V_{A} to Vₐ is V_{b}, the following relationship holds.
0.3×V_{B}−V_{A}≦V_{b}−Vₐ≦V_{B}−V_{A}

8. The image forming apparatus according to claim 5, further comprising a blade that abuts against and cleans the predetermined image forming member, wherein the rotary member supplies the toner to a portion where the blade abuts against the predetermined image bearing member.
